(19) United States
(12) Patent Application Publication
(10) Pub. No.: US 2009/0100068 A1
(43) Pub. Date: Apr. 16, 2009

(54) Digital content Management system

(76) Inventors: Ravi Gauba, Fremont, CA (US); Savitha Narayanan, Fremont, CA (US); Julian Mittchell, San Francisco, CA (US); Victor Bernard, San Jose, CA (US); Erin Glover, Fremont, CA (US); Darrell St.Blaine, Fremont, CA (US)

Correspondence Address: Ashok Tankha;Of Counsel, Lipton, Weinberger & Husick, 36 Greenleigh Drive, Sewell, NJ, 08080, US

(21) Appl. No.: 11/974,541

(22) Filed: Oct. 15, 2007

(51) Int. Cl. G06F 17/30

(52) U.S. Cl. 707/10; 707/E17.032

(57) ABSTRACT

Disclosed herein is a method and device for managing, organizing, sharing, discovering, and preserving digital media content. A user may view the digital content, metadata, and information indicating the state of the digital content using the display means provided for the digital content management device. A plurality of communication interfaces is provided on the digital content management device to interface with a plurality of local and remote devices. The digital content management device may be used to access and track the digital content on the plurality of local and remote devices. Further, a network interface is provided on the digital content management device to access a plurality of public and private networks and their associated digital content storage devices. In order to enable a user to edit, organize, share, discover, preserve, and manage the digital content, a user interface is provided for the digital content management device.

### BACKGROUND

This invention generally relates to digital media management and specifically relates to a dedicated consumer electronic device for enabling a user to edit, organize, share, manage, and preserve digital media content.

Currently, personal computers (PCs) are the prevalent choice for consumers to manage and typically store digital media such as photos, videos, music files and a variety of other digital content. Although personal computers provide the consumers with the ability to playback or access different media content formats, there are a variety of dedicated devices such as digital versatile disc (DVD) players, media players, set top boxes, etc., available for playback of each of the different media content formats. However, unlike the variety of devices available for playback, consumers have little choice for management of their digital content, other than a PC.

Hence, there is an unmet need for a dedicated method and electronic device to allow consumers to manage and preserve their digital content.

### SUMMARY OF THE INVENTION

Disclosed herein is a method and device for managing, organizing, sharing, discovering, and preserving digital media content. A user may view the digital content, metadata and information indicating the state of the digital content using a display means provided on the digital content management device. In addition or in the alternative, the user may view the digital content on a compatible external display such as a monitor or a television by connecting the digital content management device to the external display. A plurality of communication interfaces is provided on the digital content management device to interface with a plurality of local and remote devices. The digital content management device may be used to access and track the digital content on the plurality of local and remote devices. Further, a network interface is provided on the digital content management device to access a plurality of public and private networks. In order to enable the user to edit, organize, share, discover, playback, view, preserve, and manage the digital content, a user interface is provided for the digital content management device.

The digital content management device enables sharing of digital content through a single user action. The user may create local electronic albums in the digital content management device and associate the albums with friends and family. The user places the desired digital content in the albums. The albums are then automatically shared with friends and family who may have an interest in viewing such albums. The albums are dynamic containers, and have actions associated with them. For example, the user may assign a bunch of photos to an album and perform the actions associated with the album. The actions associated with different albums may include review and printing, content sharing, deferred deletion of digital content, automatic backup of content, etc.

The user performs a single pass management of digital content using the digital content management device. The user may view the content and simultaneously invoke management operations during the viewing session. The management operations supported by the device comprise tagging and sorting of digital content to albums, sharing, deleting, editing, printing, etc. The digital content accessed using the device may be automatically backed up online, on external hard disks and on optical disks such as DVDs, etc. The user may also publish and share content online with just a single user action of a user interface of the digital content management device. Further, the digital content management device enables import of digital content, through a single user action, from devices such as cameras, memory cards, compact discs or other suitable media. Once the content is imported, the digital content management device automatically creates albums and assembles the digital content by the date of creation of the digital content or the date of import of the digital content. The albums may be distinguished using unique images or icons, and the user may add text names for the albums.

The user may also perform edit operations on the digital content and create multiple copies of the digital content while retaining the original digital content. The user may track the changes made to the digital content using the metadata associated with the original digital content and the copies of the digital content. Automatically, a relationship between the edited digital content and the original digital content is created in a database for the content management device.

The digital content management device further provides visual feedback to the user about the state of the digital content. The display means presents various visual indicia related to the state of digital content through specific icons. These icons indicate one or more of the backup status of the digital content, the albums containing the digital content, whether the digital content is shared, whether the digital content is published on the web, history of viewing, and also indication of the devices storing the digital content, etc.

The digital content management device may also access multiple local and remote user devices and manage content on these devices. The digital content management device interfaces with the local and remote devices and enables the user to track content on the devices. The digital content management device seamlessly integrates multiple user computers and devices during access by recognizing the user across multiple computers and devices. The digital content may be rendered or copied to one or more of the accessed computers or devices. The method disclosed herein allows seamless streaming of the digital content within a group of devices. Further, the method allows the user to remotely access the digital content on the local user's computers and devices. The user may access the user's entire collection of content using the digital content management device over the internet.

The digital content management device enables synchronous as well as asynchronous sharing of digital content. If a digital content has to be shared with a device, the user assigns the digital content to an album associated with the user of the device and a transfer of the digital content occurs automatically. If the device is offline, the transfer is scheduled for a time when the device or the receiver becomes available.

A single piece of digital content may be assigned to multiple collections, playlists and albums while maintaining a single copy of the digital content. Each album and playlist comprises a collection of assets or metadata objects. Each asset or metadata object includes a reference to the single copy of the digital content. The digital content management device allows definition of multiple albums and manages publishing of these albums.

Digital content refers to any form of computer-readable electronic content and may comprise all forms of multimedia content, personal and professional content such as photos or images, animation, audio, graphics, videos, files, protected or encrypted content, etc.

### BRIEF DESCRIPTION OF THE DRAWINGS

The foregoing summary, as well as the following detailed description of the embodiments, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 exemplarily illustrates a method of managing and sharing digital content using a digital content management device.

FIG. 2A exemplarily illustrates a user interface view of the different media available and accessible using the digital content management device.

FIG. 2B exemplarily illustrates a user interface view of the available collections and albums on each of the different media.

FIG. 3A exemplarily illustrates a user interface view of the media management mode of operation on the digital content management device.

FIG. 3B exemplary illustrates a user interface view of the album management mode of operation on the digital content management device.

FIG. 4 exemplarily illustrates the screen shot of a user interface view of FIG. 2B.

FIG. 5 exemplarily illustrates the screen shot of a user interface view during a unified digital content viewing and management session.

FIG. 6 exemplarily illustrates the internal architecture of the digital content management device.

### DETAILED DESCRIPTION OF THE INVENTION

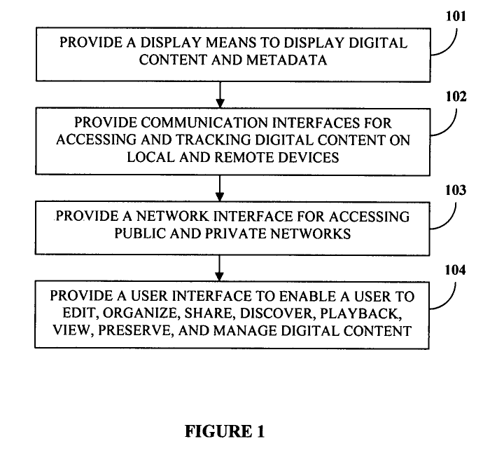

FIG. 1 exemplarily illustrates a method of managing and sharing digital content using a digital content management device. Digital content refers to any form of computer-readable electronic content and may comprise all forms of multimedia content, personal and professional content such as photos or images, animation, audio, graphics, videos, files, protected or encrypted content, etc. A user views the digital content, metadata and information indicating the state of the digital content using the display means provided on the digital content management device 101. In an embodiment of the invention, the user views the digital content on a compatible external display such as a monitor or a television by connecting the digital content management device to the external display. A plurality of communication interfaces is provided on the digital content management device to interface with a plurality of local and remote devices 102. The digital content management device may be used to access and track the digital content on the plurality of local and remote devices. Further, a network interface is provided on the digital content management device to access a plurality of public and private networks 103 and their associated digital content storage devices. In order to enable the user to edit, organize, share, discover, playback, view, preserve, and perform management operations on the digital content, a user interface is provided for the digital content management device 104. In one embodiment, the user interface provides input controls on the digital content management device. In another embodiment, the input controls are provided on a remote control unit of the digital content management device.

The input controls enable optimal user interaction with the digital content management device for managing, organizing, editing, and sharing the digital content.

A user is able to perform management operations on the digital content while viewing the digital content as part of a slide show or presentation. The user organizes the digital content by assembling the digital content into one or more local or remote electronic albums using the user interface. The user assigns the digital content to one of the electronic albums by tagging the digital content with a unique color associated with the electronic album using the “tagging” buttons on the remote control unit.

The digital content management device enables the user to perform a unified, single pass viewing and management of the digital content in a content management session. The user may manage the digital content using a user interface by performing one or more of the following actions. The user may import the digital content from one or more remote or external devices and media such as optical disks, memory cards, hard disks, etc., using the communication interfaces. The user may view the digital content on the display means, or on a television using the video out cable, as a slide show. As the user views the digital content, the user may organize the digital content into albums, rate the digital content, mark one or more of the digital content for deletion, and apply one or more editing effects to one or more of the digital content while keeping track of the relationship between the edited digital content and the original digital content. The editing operations comprise operations such as red eye reduction, rotate, crop, hue correction, sepia toning, undo effect, resizing, etc., in the case of images. The user may perform other management operations during the slide show such as organizing the digital content into albums, sharing the digital content with remote devices or users, publishing the digital content online using the network interface, etc. The system provides automated album thumbnail creating which can be optimized by the user.

The user may create local albums in the digital content management device and associate the albums with external remote and local devices or users. The contents of such albums are automatically shared with the respective devices associated with one or more remote users, friends or family. The albums are not static containers, and have actions associated with them. For example, the user may assign a plurality of photos to an album and commit the actions associated with the album. The actions associated with different albums may comprise review and printing, content sharing, deferred deletion of digital content, automatic backup of content, online publishing, etc. For example, the user may assign a digital photo to a “web publish” album. The “web publish” album is then automatically published on a desired virtual space on the web. In an embodiment of the invention, the remote and local devices accessed, printers connected to the devices, remote and local backup devices, etc., appear as albums on a user interface display. The user may assign or place digital content in one of the albums representing the devices, and the actions associated with the album are automatically performed. For example, when the user places a digital photo on an album representing a printer, the photo is automatically printed if the printer is connected to the digital content management device or queued for printing at a later time.

The input controls of the user interface may be provided on a remote control unit of the digital content management device. The input controls on the remote control unit enable optimal user interaction with the digital content management device. The remote control unit is specifically optimized for actions such as navigating through the display elements of the user interface, selecting icons on the user interface, assigning or tagging attributes such as color to the digital content, etc. This optimization allows the user to manage digital media content using the remote control unit, which does not necessitate the use of a pointer on the user interface screen. The user can move digital content within an album and between albums, tag and rate the digital content, create new play lists, edit photos, share digital content, etc. using the optimized controls of the remote control unit. The use of the remote control unit for input and the television display for the output offers an interaction experience to the user analogous to the traditional user experience with a television.

In order to assign digital content to an album or to a content collection, user customizable color coded tags are used. The user assigns a unique color to each album using the user interface, i.e., by using the colored tagging buttons on the remote control unit. The user may then tag the digital content with one of the colors associated with the albums. This associates the digital content and the digital albums tagged with the same colors. The user may remove digital content from an album by clicking a button of the same color associated with the album. The user may assign a single piece of digital content to multiple albums or collections by tagging the digital content with colors associated with respective albums. The colors associated with digital content are visually indicated on the user interface display along with the digital content. The remote control unit also comprises marker buttons for “rating” and “marking” the digital content. The user may increase or decrease the rating of a digital content or a collection of digital content using the “rating” button. The “mark” button may be used for selecting multiple items on the user interface display.

Each of the external devices accessed using the digital content management device appears as an album or icon on the user interface. In order to export digital content or a collection of content to a local or remote device, the user selects the digital content or the collection of digital content and selects the album representing the remote device. This user action automatically transfers the selected digital content or collection of digital content to the selected remote device. Similarly, the user may browse to digital content or a collection of content on a remote device and request import of the digital content to the digital content management device. In addition, the user may transfer the digital content between external devices in a similar manner.

When the user imports digital content from digital media and devices such as CDs, memory cards, remote devices, etc., a new album is automatically created for the imported digital content. The new album is created with the date of import or the date of creation of the digital content according to user preferences and configuration. In an embodiment, the first photo or video in an album is selected by default as the display icon for the album. The display icon is used to distinguish an album from other albums. The user may add a text name for each album and change the associated icon of the album. When a remote user A using a digital content management device places digital content in an album associated with user B, user B gets a message on their digital content management device indicating that new content is available for them. If user B chooses to import the digital content, the digital content gets transferred from user A's album to user B's digital content management device.

The user may also track the changes made to the digital content. In order to monitor an edited digital content, a copy of the digital content is created along with an associated metadata object. The metadata object keeps a reference to the original digital content and to the copy of the digital content. The reference to the digital content in the metadata object is a mechanism to uniquely access the piece of digital content referenced by the metadata object. This mechanism may be a URL or may be a piece of software code providing access to the digital content on execution of the software code. For example, consider the original digital content named O. The edited copy is called C. In the copy C, the parent pointer points to O and the original pointer points to O. Another edit is made to C. This copy is called D. The original pointer points to O and the parent pointer points to C. Similarly, if another edit is made on D, the copy is called E. The original pointer points to O and the parent pointer points to D. Whenever an edit is made to the digital content, a new copy of the digital content is made along with a new meta-data object. In this new meta-data object, the original reference remains the same and the parent pointer points to the digital content whose copy was made. In the above example, if D was deleted, then E's parent pointer may be updated to point to C. Additionally, if the user wants to either delete O with all its associated edits, or discover all edits associated with O, the original field in the metadata may be searched to list all the edits. Conversely, the user may trace the path back to the original digital content from any copy or version. Additionally, the metadata comprises information to track the digital content, and comprises backup history, sharing history, source information, import information, tagging and album history, viewing history, etc. In an embodiment, the digital content management device may automatically generate metadata to aid in image retrieval (colors, edges, etc.), managing text and audio annotations associated with digital content, managing relationship between the digital content, etc. A user interface may present visual indicia related to the state of the digital content, and metadata, through icons. The icons presented may indicate the backup status of the digital content, the albums containing the digital content, whether the digital content is shared, whether the digital content is published on the web, history of viewing, etc.

The digital content management device may also identify whether two content files are the same, i.e., the digital content management device may identify duplicate content. Each album keeps a reference to the digital content and not a copy of the digital content. Also, the digital content management device uses metadata to manage local and remote digital content.

In an embodiment of the invention, the digital content may be logically grouped into channels, analogous to television channels. These digital content channels may be integrated into an existing set of television channels whereby the users may seamlessly switch between regular television channels and the digital content channels. Mapping of the digital content to the channels is either performed implicitly by the digital content management device, or performed explicitly by the user. For example, the user may create a digital content channel exclusive to all the photos and a digital content channel for birthday albums, etc. The user may switch between the digital content channels using the remote control unit. In another embodiment, each of the digital content channels may comprise chapters. The chapters enables logical grouping of the digital content based on content topics and content creation sessions. The chapters represent related or specific instances of the digital content such as digital content imported in a specific session, or relating to a specific sub topic, digital content related to a specific remote or local device, etc. The user may label each digital content channel and chapter displayed on a user interface display. The user interface may display the icons and labels to indicate the title and contents of previously viewed chapters or channels. An index is automatically stored for a digital content channel when a user changes the digital content channel or when the digital content management device is powered off. When the user returns to the digital content channel, the index enables playback to be resumed from the point at which the user skipped the channel. Further, the remote control unit may provide controls to enable the users to skip backwards and forwards between and within the chapters. Also, the user may share digital content channels either in real-time, or asynchronously in order to allow another user to access the digital content on the shared channels. Real-time sharing enables controlled sharing of the channels such that the user may control the playback of both a local channel and a shared channel.

The digital content management device further enables the user to extend digital content sharing to groups of users. The digital content may be streamed between multiple networked devices. This allows optional synchronized viewing of shared digital content within a group. Two or more users located at different locations may join a conference/session and simultaneously control and view the same digital content. In an embodiment, audio and video communications may be set up on demand and on synchronizing content displayed. Also the digital content management device allows asynchronous sharing of the digital content, i.e., the digital content transfer may be delayed or scheduled to a later time, if the recipient device is not online or not available. The recipient devices comprise other networked devices, mobile phones, servers, etc. The scheduled transfer takes place when a device comes online, is powered up or connected to the network. A secure connection may be established to transfer digital content between devices.

In an embodiment of the invention, sharing of digital content may occur in a peer-to-peer fashion, i.e., without an intermediate server. The digital content management device has the ability to discover similar devices on a local network or on a specified remote network to enable direct connectivity for sharing, managing and controlling the digital content on the remote devices.

The digital content management device may stream and/or download online digital content and manage the digital content for the user. The digital content management device allows the user to manage the online or downloaded digital content and provides a unified user experience with respect to all the digital content. For example, the user may register with multiple websites such as YouTube of Google Inc., and websites associated with the American Broadcasting Company, the National Broadcasting Company (NBC), etc. and download digital content or subscribe to the websites for streaming the digital content. The digital content management device provides for the unified management and viewing of online digital content such as my favorite YouTube channels, NBC news, published photos on Snapfish of Hewlett-Packard Co., and other paid online video content. The digital content management device provides a uniform user interface with a unified look and feel for all the digital content and for the management of the digital content.

The user may also associate audio metadata with the digital content and the digital content management device may provide audio narration of the audio metadata. The digital content management device may enable the user to add voice and text annotations to the digital content. The user may add voice and text notes to the digital media that may be a shared, real-time or asynchronously, with other users. Users may access each other's voice and text notes on the devices at their end. In an embodiment, the remote control unit or the digital content management device may have a built-in audio recorder used for adding voice notes to the digital content.

If the user deletes a digital content, the backup of the digital content may also be deleted. However, deletion synchronization may be delayed by some period of time in order to recover the digital content accidentally cleared from the trash. In order to free up memory space on the digital content management device, a set of “least viewed photos” may be pulled up to be easily viewed and trashed as desired by the user. The information on viewing history of the digital content is maintained in the associated metadata, and the user may be notified and the set of “least viewed photos” may be pulled up from time to time.

Multiple user accounts may be established on the digital content management device such that content rendering and presentation, privileges, access to the digital content, etc. may be customized and controlled for each user. The digital content management device enables users to manipulate multiple photos simultaneously by selecting a set of photos or all photos in an album. The user may digitally manipulate a copy of the digital content to represent the state of the digital content. For example, the user may sepia tone a copy of a photo to represent an old image.

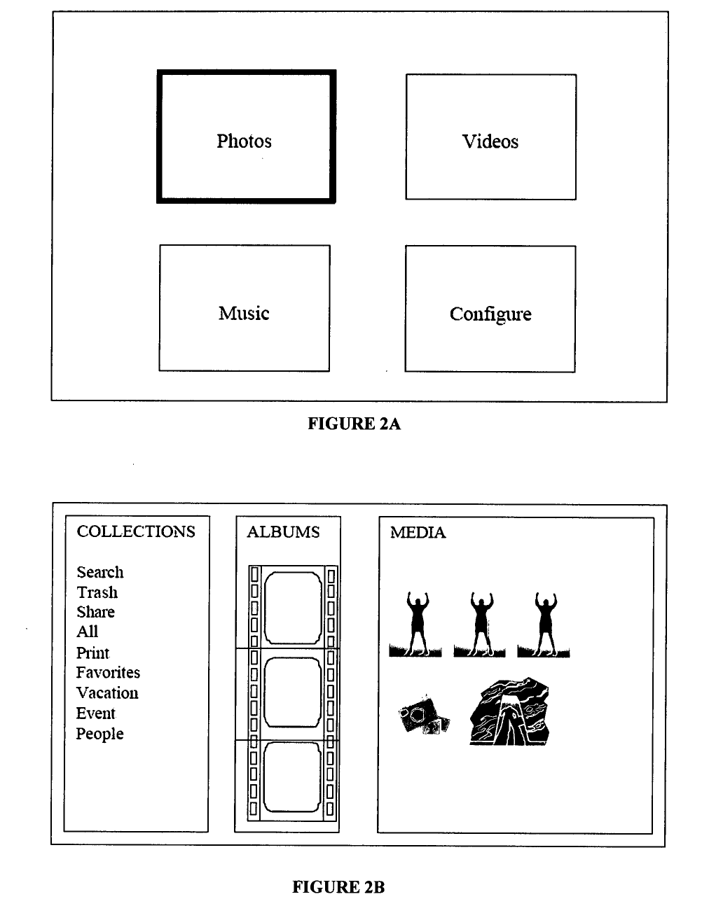

FIG. 2A exemplarily illustrates a user interface view of the different media collections available and accessible using the digital content management device. This view is displayed upon startup, or on pressing the “home” button on the remote control unit. A user may choose the type of media that the user wishes to browse. Throughout the viewing process, the user may set or activate audio playback of either pre-canned or user installed music.

FIG. 2B exemplarily illustrates a user interface view of the available collections and albums on each of the different media. Upon user selection of a particular media on the home page of FIG. 2A, the user is brought to the collections and albums view as illustrated in FIG. 2B. User interface view may vary depending on the selection of media type. This view presents the available collections and albums of the media type selected, and a media area. The cursor or focus is initially on the collections column, where the user may scroll up and down the collections. When the user selects one of the collections the focus moves to the albums column. The user may scroll through the albums and also move the focus back to the collections column using the controls on the remote control unit. When the focus moves to an album, the digital content assembled in the highlighted album is shown in the media area. For example, when a photo album is highlighted, the photos in the album are shown in the media area. The photos in the media area may be ordered or presented as a floating collage of photos. Pressing the “play” button on the remote control unit, starts a slideshow of the photos assembled in the highlighted collection or album. The user may use the browsing controls on the remote control unit to move faster through the photos during the slideshow and to skip between albums in the slideshow. The user may exit the slideshow and enter the collections or albums view at any point.

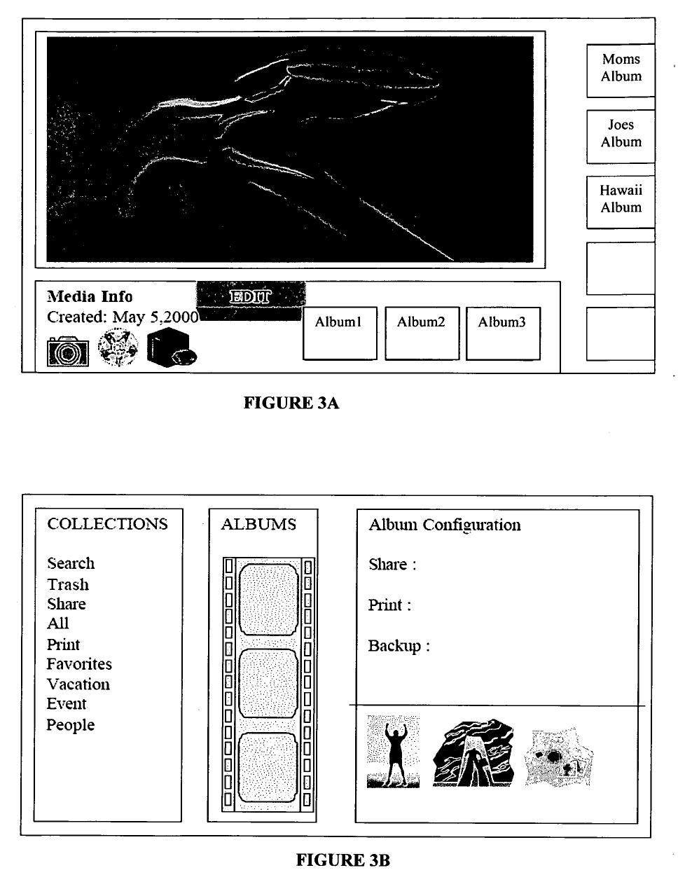

FIG. 3A exemplarily illustrates a user interface view for the media management mode of operation on the digital content management device. At any point during a slideshow, the user may press the “info/edit” button and enter the media management mode illustrated in FIG. 3A. In the media management mode, the user may color tag and associate the particular media content to multiple collections and albums. Common photo editing functions such as rotate, crop, color correct, etc., are available to the user in the media management mode. The media management view provides the user detailed information about the digital content. For example, the information on a photograph may comprise the date and time on which the photo was created, backup status, sharing history, publishing history, etc. The user may also disassociate or remove the photo from an album by selecting the album icon on the “media info” bar and clicking the “trash” button.

FIG. 3B exemplary illustrates a user interface view for the album management mode of operation on the digital content management device. To enter the album management mode, the user selects an album and presses the “info/edit” button. The album management mode provides the user detailed information about the album and the album's properties. The user may share the selected album causing the album to appear under the “share” collection. In the album management mode of operation, the user may transfer the contents of the album to an external device such as a remote storage device, a printer, etc.

The user may share multiple albums with an external device or user. Hence, in the “share” collection, multiple shared albums may appear under a single device or a single user. Color coding may be applied to shared albums such that the albums shared with a particular external user are associated with a unique color. The shared albums related to other users may be accessed by skipping through the “share” collection. In order to associate an album with a particular color tag, the user enters a “set album mode” provided on a user interface of the digital content management device. The user may then choose a collection and an album. To tag the album with a particular color, the user presses the color button of choice on the remote control unit. The remote control unit may have ‘n’ color buttons used to uniquely color tag ‘n’ different albums. In an embodiment, the albums may be tagged using symbols. In another embodiment, the albums or the digital content may be tagged using numbers. In the embodiment of tagging using numbers, the user may associate a specific number to an album by selecting the number from the channel number menu on the remote control unit. In another embodiment, the user may assign digital content to albums by clicking the numbers associated with the albums at the collections and albums view mode of FIG. 2B.

The user may also import digital content from external devices with a single button press. The user may insert a memory card or connect a universal serial bus (USB) device to the digital content management device to import the digital content. The digital content management device has a specific button enabling the import of the digital content from the devices connected to the digital content management device. The user may also import the digital content using a user interface view where the external device appears as an icon or an album. A user interface also provides a “guided import” process, which allows the user to add and immediately manage or organize new media content. In the “guided import” mode, the user is walked through the process of creating and naming a new album for the imported digital content. The user is also given the opportunity to assign or tag colors to the albums, and then shown a slideshow of the new digital content. During the slideshow the user may organize and manage the digital content as described in the description of FIG. 1.

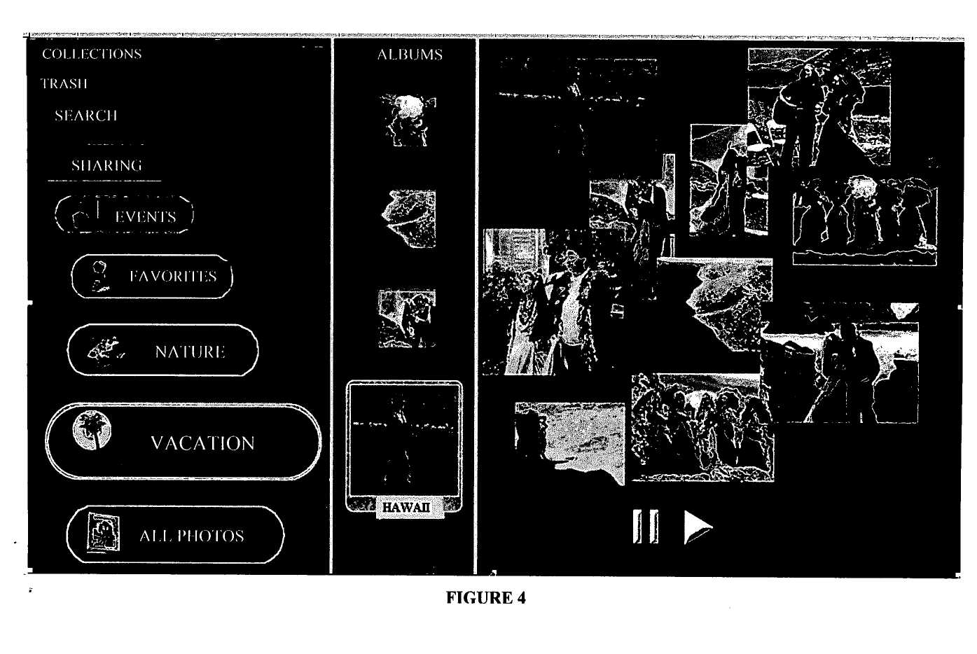

FIG. 4 exemplarily illustrates the screen shot of a user interface view of FIG. 2B. Similar to the albums created by the user, the external devices such as printer, storage devices, etc., may show up as albums. Also, specific collections may be created for backed up digital content and shared digital content as “backup” and “share” collections respectively.

The user, for example, may backup digital content by associating the same tag to the digital content as that associated with the backup album or collection. The digital content backed up may be viewed as part of the backup album or collection. If at any point the user wishes to identify the shared or backed up digital content, the user has to move the focus to the right album. Similarly, the user may determine what digital content has been transferred to user devices such as MPEG-1 audio layer 3 (MP3) players. At any point the user may find out what digital content has been transferred to a device album, even when the actual device, such as an MP3 player, is not connected. The digital content management device provides a mechanism for printing locally or remotely. Printing may also be performed during the unified content viewing and management session. The digital content management device may include specific buttons for printing such that the digital content may be printed with a single user action. Further, the digital content management device may support printing to a local printer such as a printer on a base station. The digital content management device may communicate with the printer using common network standards defined by Wi-Fi, 802.11, Bluetooth, etc.

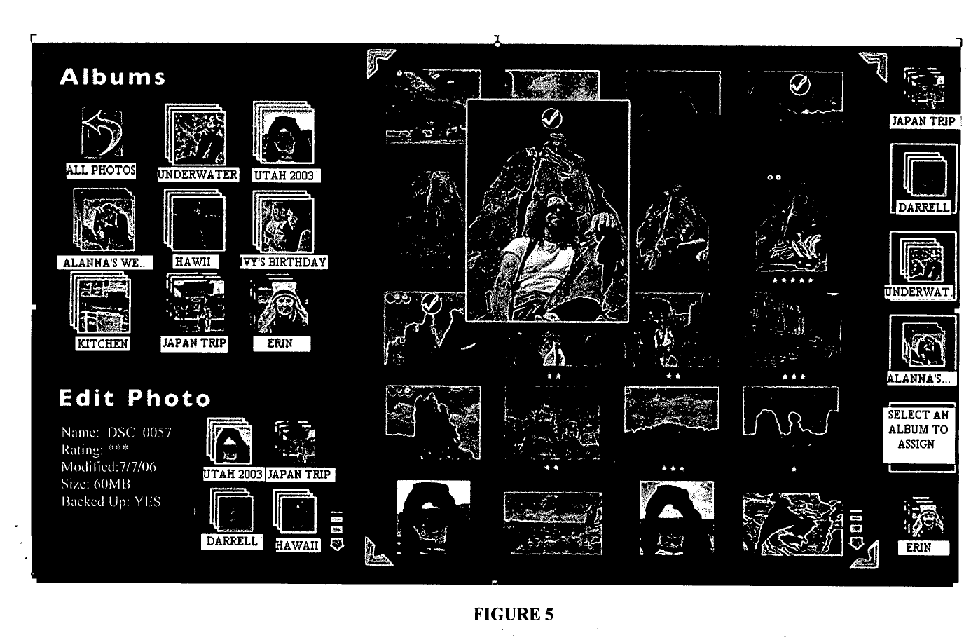

FIG. 5 exemplarily illustrates the screen shot of a user interface view during a unified digital content viewing and management session. For example, the user interface of FIG. 5 allows the user to view and manage multiple photos simultaneously. The user can rate, tag, and edit the photos using the user interface. The user may browse to a specific photograph and may simultaneously add the photo to multiple albums using the colored tagging buttons on the remote. The user can go to the “Edit Photo” section and perform specific functions on the photo. The user can edit the name of the photo, annotate the photo, and associate the photo with a different album(s).

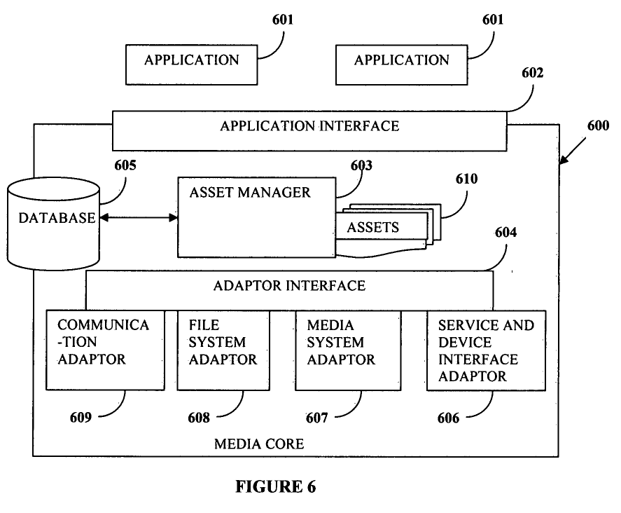

FIG. 6 exemplarily illustrates the internal architecture of the digital content management device. The details of this architecture are set out in the co-pending application Ser. No. 11/656,191 titled “Distributed Digital Media Management”, which is referenced herein in its entirety. Media Core 600 is the core framework on which the content management application is built, and comprises an application interface 602, an asset manager 603, and an adaptor interface 604.

Application Interface 602: Application Interface 602 is an application programming interface (API) used to connect the applications 601 with the Media Core 600 and to access the assets 610 in the digital content management device. The application interface 602 is used for support management and discovery of metadata objects. Assets 610: Each item in the digital content management device is represented as an asset 610 and accessed by the application 601 through the asset interface. An asset 610 associates the digital content and metadata together. Metadata is information on the digital content and other information required to control and manage the digital content. Asset Manager 603: The asset manager 603 manages the assets 610 in the digital content management device. Any component requiring an asset 610 queries the asset manager 603 for the asset 610. The digital content management device may comprise an internal storage for storing the digital content and the associated metadata. The asset manager 603 may be configured to run using a database 605 or using transient memory to store the assets 610.

Adaptor Interface 604: Adaptor Interface 604 is the interface to install and manage several adaptors in the digital content management device. The adaptors introduce assets 610 or metadata objects into the asset manager 603. The adaptors defined in the Media Core 600 comprise a communication adaptor 609, a file system adaptor 608, a media system adaptor 607, and a service and device interface adaptor 606. The architecture may provide extensibility and/or forward compatibility to include other adaptors for later versions of the digital content management device.

Communication Adaptor 609: The communication adaptor 609 is used for sharing and communicating with remote media core devices.

File System Adaptor 608: The file system adaptor 608 is used to introduce digital content, in the form of files, as assets or metadata objects into the media core 600.

Media System Adaptor 607: The media system adaptor 607 is used to edit and trans-code the digital media files.

Service and Device Interface Adaptor 606: The service and device interface adaptor 606 is used to discover and introduce assets or metadata objects from service providers such as online content from websites. The service and device interface adaptor 606 is also used to interface with a heterogeneous set of devices and may use specific device drivers to introduce content present on these device into the media core 600.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A ‘processor’ means any one or more microprocessors, Central Processing Unit (CPU) devices, computing devices, microcontrollers, digital signal processors or like devices. The term ‘computer-readable medium’ refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

Where databases are described such as database 605, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, Sun® processors, AMD® processors, IBM® processors, etc. that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A method of managing and sharing digital content using a digital content management device, comprising the steps of:
providing a display means on said digital content management device for displaying said digital content, metadata, and information indicating the state of the digital content, wherein said display means is one of an internal display and/or an external display;
providing a plurality of communication interfaces for interfacing the digital content management device with a plurality of local and remote devices and accessing and tracking the digital content on said plurality of local and remote devices;
providing a network interface for accessing a plurality of public and private networks; and
providing a user interface for the digital content management device for enabling a user to manage the digital content, wherein said user interface provides input controls on one of the digital content management device and a remote control unit of the digital content management device, wherein said input controls enable optimal user interaction with the digital content management device for managing the digital content.

2. The method of claim 1, wherein said step of managing the digital content comprises one or more of the steps of editing, organizing, sharing, discovering, preserving, replaying and viewing the digital content.

3. The method of claim 1, wherein said user organizes the digital content by assembling the digital content into one or more local or remote electronic albums using the user interface, wherein the user assigns the digital content to one of said electronic albums by tagging the digital content with a unique attribute associated with one of the electronic albums using tagging buttons of the user interface, wherein said unique attribute may be one of a unique color, a unique number, and a unique symbol.

4. The method of claim 3, wherein the user assigns digital content to more than one of the electronic albums and/or collections while maintaining a single copy of said digital content.

5. The method of claim 1, wherein said user performs management operations on the digital content during single pass viewing of the digital content as part of a slide show or presentation.

6. The method of claim 1, wherein said user performs a single pass management of the digital content in a content management session using said user interface by performing one or more of the steps of:
importing the digital content from one or more of said local and remote devices using said communication interfaces;
viewing the digital content on said display means or on a television by connecting the digital content management device to said television;
organizing the digital content into albums;
rating the digital content;
marking one or more of the digital content for deletion; and
editing one or more of the digital content and keeping track of the relationship between modified digital content and the original digital content.

7. The method of claim 1, wherein the digital content is logically grouped into digital content channels, wherein mapping of the digital content to said digital content channels is performed implicitly by the digital content management device or performed explicitly by the user.

8. The method of claim 7, wherein the digital content channels are integrated into an existing set of television channels, whereby the user can seamlessly switch between regular television channels and the digital content channels exported by the digital content management device.

9. The method of claim 7, wherein each of said digital content channels further comprises chapters, wherein each of said chapters enables logical grouping of the digital content based on content topics, content creation sessions, and the relation of the content to remote and local devices.

10. The method of claim 1, further comprising the step of associating audio metadata with the digital content and providing audio narration of said audio metadata by the digital content management device, whereby the user adds audio and text annotations to the digital content.

11. The method of claim 1, wherein said user manages the digital content by transferring one or more of the digital content to and from one or more of said local and remote devices.

12. The method of claim 1, wherein said user dynamically shares the digital content by assigning one or more of the digital content to one or more local albums, wherein each of said local albums is assigned to addresses of one or more of said local and remote devices associated with one or more users.

13. The method of claim 12, further comprising real time sharing of the digital content between users remote to each other for simultaneous viewing and control of the digital content, wherein said step of sharing comprises sharing of metadata including text and audio annotations associated with the digital content

14. The method of claim 1, wherein said user manages the digital content by enabling an automatic backup feature for the digital content, wherein the digital content assigned with said automatic backup feature is backed up along with associated metadata on one of local or remote storage devices or online storage.

15. The method of claim 1, wherein said user manages the digital content on one of the digital content management device and said local and remote devices using said communication interfaces of the digital content management device.

16. The method of claim 1, wherein said user manages the digital content on multiple networked local devices.

17. The method of claim 16, wherein the user streams and transfers the digital content between said networked local devices.

18. The method of claim 1, wherein said metadata comprises information to track the digital content, backup status and history, sharing history, source information, import information, and tagging and album history.

19. The method of claim 1, wherein said user creates multiple copies of the digital content and tracks changes made to the digital content using metadata associated with the original and said copies of the digital content.

20. The method of claim 1, wherein said display means presents visual indicia related to the state of the digital content through icons, wherein said icons indicate one or more of the backup status of the digital content, the albums containing the digital content, sharing status and history, publication history, user rating, original or a copy, and history of viewing.

21. The method of claim 1, wherein said user manages digital content in one of a media management mode and a album management mode, wherein the album management mode allows the user to manage and share the contents of an album.

22. The method of claim 1, wherein said user shares the digital content by publishing the digital content online using said network interface.

23. The method of claim 1, wherein said user streams and downloads online digital content, wherein the user manages and views the online digital content using the user interface.

24. A digital content management device for managing and sharing digital content comprising:
a display means for displaying said digital content, metadata, and information indicating state of the digital content, wherein said display means is one of an internal display and an external display;
a plurality of communication interfaces for interfacing said digital content management device with a plurality of local and remote devices and accessing and tracking the digital content on said plurality of local and remote devices;
a network interface for accessing a plurality of public and private networks; and
a user interface for enabling a user to manage the digital content, wherein said user interface provides input controls on one of the digital content management device and a remote control unit of the digital content management device, wherein said input controls enable optimal user interaction with the digital content management device for managing the digital content.

25. The device of claim 24, wherein the user interface enables the user to perform management operations, wherein said management operations comprise editing, organizing, sharing, discovering, preserving, replaying and viewing the digital content.

26. The device of claim 24, wherein said digital content management device comprises one of an internal storage and an external storage for storing the digital content and the associated metadata.

27. The device of claim 24, wherein said digital content management device comprises a video out means to transfer the digital content to said external display for viewing purposes, wherein the external display is one of an external composite monitor and a television.

28. The device of claim 24, wherein said local devices are storage devices comprising memory cards, universal serial bus flash drives, optical discs, computer hard drives or other suitable storage media.

29. The device of claim 24, wherein said communication interfaces comprise memory card readers and a plurality of data transfer and communication ports.

30. The device of claim 24, wherein the input controls on said remote control unit enable optimal user interaction with the digital content management device for the steps of managing, organizing, editing, and sharing the digital content.

31. The device of claim 24, wherein the remote control unit comprises a built-in audio recorder, wherein the user records and associates voice notes to the digital content using said built-in audio recorder.

32. The device of claim 24, further comprising adaptor components that provide the ability to communicate with one or more of said local and remote devices, the functionality to create metadata objects representing the digital content on the local and remote devices, and the ability to discover and introduce metadata objects from online digital content.

33. The device of claim 24, further comprising an application interface for support management and discovery of metadata objects.

34. The device of claim 24, further comprising an asset manager for managing the metadata objects in the digital content management device, wherein said asset manager is configured to use a database or a transient memory to store the metadata objects.
